(19) United States
(12) Patent Application Publication
(10) Pub. No.: US 2003/0187637 A1
(43) Pub. Date: Oct. 2, 2003

(54) Automatic feature compensation based on decomposition of speech and noise

(75) Inventors: Hong-Goo Kang, Chatham, NJ (US); Hong Kook Kim, Chatham, NJ (US); Richard Cameron Rose, Watchung, NJ (US)

Correspondence Address: OLIFF & BERRIDGE, P.O. BOX 19928, ALEXANDRIA, VA, 22320, US

(73) Assignee: AT&T, New York, NY

(21) Appl. No.: 10/108,634

(22) Filed: Mar. 29, 2002

(51) Int. Cl. G10L 21/02

(52) U.S. Cl. 704/226

(57) ABSTRACT

The invention provides devices and methods to decompose the noise-corrupted speech into an estimate for the clean speech component and an estimate for a noise component in a domain wherein the two components additively interact. In one implementation, the noise-corrupted speech signal is transformed into the cepstrum domain and combined with a cepstrum of a nonlinear gain function representing noise to obtain an estimate of the clean speech component in the cepstrum domain. In another implementation, the clean speech component is decomposed from the background noise component and channel distortion in the noisy speech cepstrum domain.

### BACKGROUND OF THE INVENTION

1. Field of Invention

This invention relates to speech processing. More particularly, this invention relates to systems and methods that compensate features based on decomposing speech and noise.

2. Description of Related Art

Speech often is accompanied by acoustic background noise; noise that is due to the environment wherein speech takes place or is due to the channel through which speech is communicated. The noise that accompanies speech can complicate processing a signal including the speech and the noise when attempting to enhance the speech component of the signal over the noise component of the signal, or in attempting automatically to recognize the words in the speech.

Speech and the background noise are additive in the linear spectrum domain. The interaction between the speech and accompanying noise, however, is more difficult to characterize in the nonlinear spectral domains, including the log spectral amplitude and the cepstrum domains. Indeed, the speech and the accompanying noise interact in a highly non-linear manner in the cepstrum domain.

The absence of simple characterization for the interaction between speech and the background noise in non-linear spectral domains complicates the application of speech processing techniques, including using Hidden Markov Model (HMM) compensation and feature compensation in automatic speech recognition (ASR) techniques. Such complications render difficult obtaining the clean speech component of a noise-corrupted speech. The difficulty in obtaining the clean speech component deleteriously affects subsequent stages in the processing of noise-corrupted speech because complex, costly, and slow processing is necessary to obtain an estimate of the clean speech component.

Therefore, there exists a need for devices and methods that can readily obtain an estimate of the clean speech component of a noise-corrupted speech.

### SUMMARY OF THE INVENTION

The invention provides a device and methods that readily separate the clean speech component in a noise-corrupted speech. The invention improves the processing of speech to enhance its clean speech component and increases the accuracy of ASR applications in a simple, inexpensive, and relatively fast manner.

In its most basic approach, the invention decomposes the noise-corrupted speech into an estimate for the clean speech component and a noise component in a domain wherein the two components non-linearly interact to form the noise-corrupted speech. The invention thus simplifies the processing of noise-corrupted speech.

In one exemplary embodiment, an estimate of the clean speech component and a noise component are decomposed in the noisy speech cepstrum domain. This is achieved by obtaining the estimated clean speech cepstrum by combining a noise cepstrum (obtained based on a non-linear gain function describing the noise) with the noise-corrupted speech cepstrum.

In another exemplary embodiment, an estimate of the clean speech component is decomposed from a background noise component and an estimate of channel distortion effects in a noise-corrupted speech cepstrum domain. This is achieved by obtaining an estimate of the clean speech cepstrum by combining a noise cepstrum representing the environment (obtained based on a non-linear gain function describing the noise) with the noise-corrupted speech cepstrum with an estimate of channel distortion effects.

These and other features and advantages of this invention are described in or are apparent from the following detailed description of the system and method according to exemplary embodiments of this invention.

### BRIEF DESCRIPTION OF THE DRAWINGS

The benefits of the present invention will be readily appreciated and understood from consideration of the following detailed description of exemplary embodiments of this invention, when taken together with the accompanying drawings, in which:

FIG. 1 is a block diagram of an exemplary device in accordance with the present invention that estimates a clean speech component in a noise-corrupted speech;

FIG. 2 is a block diagram of an exemplary device in accordance with the present invention that estimates a clean speech component in a noise-corrupted speech, wherein the sub-circuits obtaining c_{y} and c_{gω} are connected in parallel;

FIGS. 3A-3C are plots showing speech waveforms and the mel-cepstral distances after applying several processing techniques; FIG. 3A is a plot of clean speech waveform of a connected digit string “34126” spoken by a male; FIG. 3B is a plot of noisy speech waveform, which is corrupted by car noise at 10 dB SNR; and FIG. 3C is a plot of the mel-cepstral distances (MCD) between FIG. 3A and FIG. 3B, computed using the baseline conventional (_), SE (...) using an approach wherein the gain function is implemented within a conventional arrangement, and the CSM (---) methods;

FIG. 4 is a block diagram of an exemplary device in accordance with the present invention that estimates a clean speech component in a noise-corrupted speech including channel corruption effects;

FIG. 5 is a flowchart depicting the steps of an exemplary method in accordance with the present invention that estimates a clean speech component in a noise-corrupted speech;

FIG. 6 is a flowchart depicting the steps of an exemplary method in accordance with the present invention that estimates a clean speech component in a noise-corrupted speech; and

FIG. 7 is a flowchart depicting the steps of an exemplary method in accordance with the present invention that estimates a clean speech component in a noise-corrupted speech including channel corruption effects.

### DETAILED DESCRIPTION OF PREFERRED EMBODIMENTS

In this Application, the value of a variable in the cepstrum domain is obtained by first transforming the variable, next optionally weighting bands of the variable in the transform domain by different values, followed by applying a homomorphic function on the transformed and optionally weighted variable, followed by inverse transforming the result of the homomorphic function. Examples of transform functions include, but are not limited to the Fourier Transform, the Fast Fourier Transform, the Cosine Transform, and the Discrete Cosine Transform. Examples of differently weighting bands of the transformed variable include, but are not limited to, using triangular weighting, Gaussian weighting, parabolic weighting, or rectangular weighting with different weighting factors. Such optional weighting may be based on previously determined factors or may be based on dynamically determined factors.

Additionally, in this Application, a homomorphic function is characterized by transforming a multiplication (division) relationship between variables into an additive (subtractive) relationship between the variables. Examples of a homomorphic function include, but are not limited to, the logarithm (natural base or any other base, including integer, rational and irrational numbers) function and series expansion approximations for the logarithm function. Chapter 7 of “Digital Processing of Speech Signals,” by Lawrence R. Rabiner and Ronald W. Schafer (1978), which is titled Homomorphic Speech Processing, which is explicitly incorporated herein in its entirety and for all purposes, describes homomorphic functions.

FIG. 1 is a schematic diagram showing a non-limiting and exemplary implementation of the invention as apparatus 100. Apparatus 100 includes an input 102 receiving a signal, a circuit 104 processing the signal, and an output 106 outputting an output signal.

In a non-limiting and exemplary implementation, the apparatus 100 directly receives at input 102 a signal representing noise-corrupted speech. In another non-limiting and exemplary implementation, apparatus 100 receives at input 102 a signal representing speech after it has been preprocessed. Such a preprocessed signal includes, but is not limited to, speech that has undergone amplification or filtering.

The circuit 104 is operatively connected to the input 102, from which it receives the input signal. The circuit 104 is operatively arranged to process the input signal and obtain an estimate of the clean speech component of the noise-corrupted speech. In a non-limiting and exemplary implementation, the circuit 104 obtains in the cepstrum domain the estimated clean speech component of the noise-corrupted speech.

Output 106 is operatively connected to the circuit 104 and outputs a signal based on the result of the processing performed by circuit 104.

In a non-limiting and exemplary implementation of using the apparatus 100, the signal outputted by output 106 is then optionally further processed by other devices or systems. For example, an output signal representing the estimated clean speech may be fed into an ASR system to determine the words in the clean speech included in the output signal. In another example, the output signal is then optionally further processed.

In a non-limiting and exemplary implementation, the circuit 104 is operatively arranged, preferably, (1) to obtain a frequency dependent non-linear gain function, (2) to obtain the transform of the input noise-corrupted speech signal, and (3) combine (e.g., by adding) signals based on the obtained non-linear gain function and the obtained transform of the noise-corrupted speech signal.

Specifically, let S(ω)=A(ω)exp(jφ(ω)), W(ω), and Y(ω)=R(ω)exp(jθ(ω)) be the Fourier expansions of clean speech s(n), additive noise w(n), and noisy speech y(n), respectively. Then, an objective of the exemplary implementation is to find an estimator Â(ω) that minimizes a measure of the distortion measure by minimizing E{((log A(ω)−log Â(ω))²} for a given noisy observation spectrum Y(ω). Such minimization of the distortion measure yields an estimate of the clean speech spectrum that has the form:

Â(ω)=G_{M}(ω)G_{LSA}(ω)R(ω)=G_{ω}(ω)R(ω) (1)

where G_{M}(ω) is a gain modification function and G_{LSA}(ω) is the gain function. G_{M}(ω) represents the probabilities of speech being present in frequency ω and can be referred to as the soft-decision modification of the optimal estimator, and G_{ω}(ω) represents the frequency dependent gain function.

Further, if the inverse Fourier transform of G_{ω}(ω) is g_{ω}(n), then the enhanced signal, ŝ(n), is given by:

ŝ(n)=y(n)*g_{ω}(n)=(s(n)+w(n))*g_{ω}(n) (2)

where y(n) is the noise-corrupted speech and w(n) is the noise. Assuming that the enhanced speech signal is an estimate of the clean speech signal, the cepstrum for clean speech, c_{ŝ}, is approximated as

c_{ŝ}=c_{y}+c_{gω.} (3)

According to (3), the noise-corrupted speech cepstrum, c_{y} can be decomposed into a linear combination of the estimated clean speech cepstrum, c_{ŝ}, and noise cepstrum, c_{gω.} This approach can be referred to as the cepstrum subtraction method (CSM).

In a non-limiting and exemplary implementation, circuit 104 is operatively arranged to include two sub-circuits, each obtaining one of c_{y} or c_{gω}. In a non-limiting and exemplary implementation, the two sub-circuits are connected in parallel. In another exemplary implementation, the two sub-circuits are connected in series. In another exemplary implementation, the circuit 104 has a single sub-circuit that obtains c_{y} and c_{gω}.

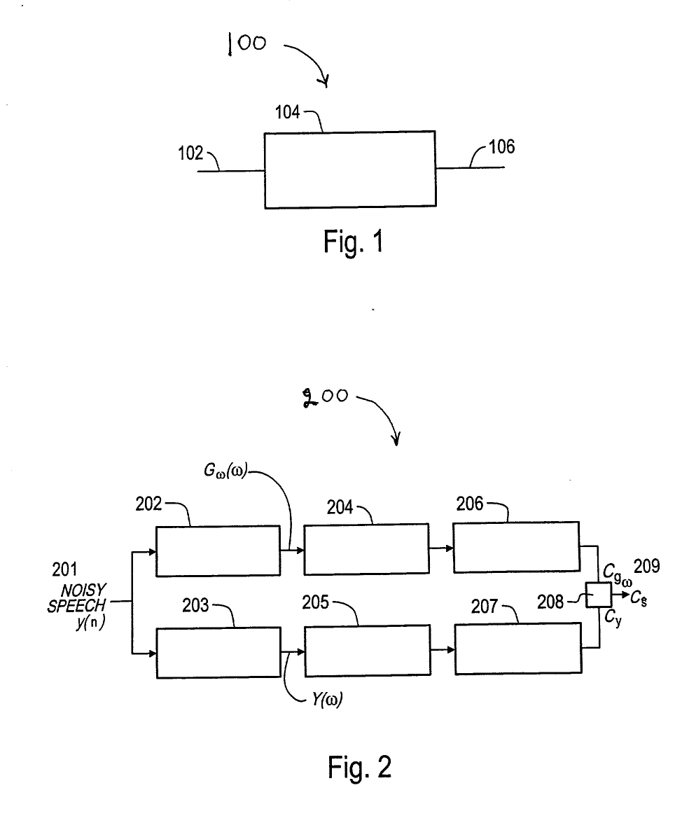

FIG. 2 is a schematic of a block diagram showing a non-limiting and exemplary implementation of circuit 104, as apparatus 200, wherein the sub-circuits obtaining c_{y} and c_{gω} are connected in parallel. Apparatus 200 can include an input 201, a nonlinear filter generator 202, a transform generator 203, filter-bank analysis circuits 204 and 205, inverse transform generators 206 and 207 (exemplarily implemented as inverse discrete cosine transform generators IDCTs; however, it should be understood that other function transforms may be used instead of the cosine transform without departing from the spirit and scope of the present invention; exemplary implementations of the inverse transform generators 206 and 207 preferably use the same, or different, inverse transform functions), a combiner 208, and an output 209.

The input 201 is operatively arranged to receive the noise-corrupted speech y(n). The input 201 provides the received signal to the nonlinear filter generator 202, which is operatively arranged to obtain the frequency dependent gain function G_{ω}(ω). Next, the filter-bank analysis circuit 204 operates on G_{ω}(ω) by optionally weighting G_{ω}(ω) in different bands by different values and by applying a homomorphic function on the transformed and optionally weighted result. The inverse transform generator 206 operates on the output of the filter-bank analysis circuit 204 by applying an inverse transform to obtain the noise mel-frequency cepstrum coefficients (MFCC's). Thus, c_{gω} is obtained. In a non-limiting and exemplary implementation, the inverse discrete cosine transform is used as the inverse transform circuit 206 performing the inverse transform.

In a non-limiting and exemplary implementation, the filter-bank analysis circuit 204 optionally weights G_{ω}(ω) in different bands by different values by using triangular shaped weight distributions, optionally having different heights, for each band. Other exemplary non-limiting implementations of the filter-bank analysis circuit 204 include rectangular, parabolic, or Gaussian shaped weighting distributions. The shape and height of the weighting distributions used in the exemplary implementations can be predetermined or dynamically determined. Examples of a homomorphic function that the filter-bank applies on G_{ω}(ω), which may be optionally weighted as described above, include, but are not limited to, the logarithm (natural base or any other base, including integer, rational and irrational numbers) function and series expansion approximations for the logarithm function.

The input 201 also provides the received signal to the transform generator 203, which is operatively arranged to obtain the transform, Y(ω), of the noise-corrupted speech signal. Next, the filter-bank analysis circuit 205 operates on Y(ω) by optionally weighting Y(ω) in different bands by different values and by applying a homomorphic function on the transformed and optionally weighted result. The inverse transform generator 207 operates on the output of the filter-bank analysis circuit 205 by applying an inverse transform to obtain the MFCC's of the noise-corrupted speech signal. Thus, c_{y} is obtained.

In a non-limiting and exemplary implementation, the filter-bank analysis circuit 205 optionally weights Y(ω) in different bands by different values by using triangular shaped weight distributions, optionally having different heights, for each band. Other exemplary non-limiting implementations of the filter-bank analysis circuit 205 include rectangular, parabolic, or Gaussian shaped weighting distributions. The shape and height of the weighting distributions used in the exemplary implementations can be predetermined or dynamically determined. Examples of a homomorphic function that the filter-bank applies on Y(ω), which may be optionally weighted as described above, include, but are not limited to, the logarithm (natural base or any other base, including integer, rational and irrational numbers) function and series expansion approximations for the logarithm function.

In a non-limiting and exemplary implementation, the transform generator 203 obtains the Fourier Transform of the noise-corrupted speech. In a non-limiting and exemplary implementation, a short-time Fast Fourier Transform is used in the transform generator 203 to obtain Y(ω). In a non-limiting and exemplary implementation, the inverse discrete cosine transform as the inverse transform circuit 207 performing the inverse transform.

Next, the obtained c_{y} and c_{gω} are preferably combined in combiner 208 (for example, by being added) and made available at output 209 for further optional processing.

A non-limiting and exemplary implementation of the nonlinear filter generator 202 is based on obtaining the gain function G_{ω}(ω) using an approach to minimizing the mean squared error log spectral amplitude that includes a soft-decision based modification, as described in “Tracking Speech Presence Uncertainty To Improve Speech Enhancement in Non-stationary Noise Environments,” by D. Malah, R. V. Cox, and A. J. Accardi, in Proc. ICASSP, Phoenix, Ariz., vol. 2, pp. 789-792, March 1999, which is explicitly incorporated herein by reference in its entirety and for all purposes.

According to this approach, G_{LSA}(ω) is derived as

$$\begin{matrix}\begin{matrix}{G}_{LSA} ( ω ) = \frac{ξ ( ω )}{1 + ξ ( ω )} exp ( \frac{1}{2} {\int }_{υ ( ω )}^{∞} \frac{{ⅇ}^{- t}}{t} ⅆ t ) \\ where υ ( ω ) = \frac{ξ ( ω )}{1 + ξ ( ω )} γ ( ω ) , γ ( ω ) = \frac{{R}^{2} ( ω )}{λ ω ( ω )} , ξ ( ω ) = \frac{η ( ω )}{1 - q ( ω )} , \end{matrix} \\ η ( ω ) = \frac{{λ}_{s} ( ω )}{{λ}_{ω} ( ω )} , {λ}_{s} ( ω ) = E \{ {\vert S ( ω ) \vert}^{2} \} = E \{ {A}^{2} ( ω ) \} , and {λ}_{ω} ( ω ) = E \{ {\vert W ( ω ) \vert}^{2} \} .\end{matrix} \qquad ( 4 )$$

γ(ω) is called the a posteriori signal-to-noise ratio (SNR), η(ω) is called the a priori SNR, and q(ω) is the prior probability that there is no speech presence in frequency ω. Additionally, λₛ(ω) and λ_{w}(ω) denote the power spectral densities (psd's) of speech and noise signals, respectively.

The estimation of the noise psd, λ_{w}(ω) affects equations (1) and (4). The results presented herein are based on using a spectral minimum tracking approach for estimating λ_{w}(ω), as described in “Spectral Substraction Based on Minimum Statistics,” by R. Martin, in Proc. Euro., Signal Process. Conf. (EUSIPCO), Edinburgh, UK, pp. 1182-1185, September 1994, which is incorporated herein by reference in its entirety and for all purposes. It should be understood that the use of this method is exemplary and other methods may, instead or in addition, be used in practicing this invention.

In contrast to voice activity detection oriented approaches, the minimum tracking method does not require explicit thresholds for identifying speech and noise-only intervals. The method determines the minimum of the short-time psd estimate within a finite window length and assumes that the bias compensated minimum is the noise psd of the analysis frame. Since the minimum value of a set of random variables is smaller than their mean, the minimum noise estimation generally is biased. This approach works well in real communication environments where the channel conditions are slowly varying with respect to the analysis frame length.

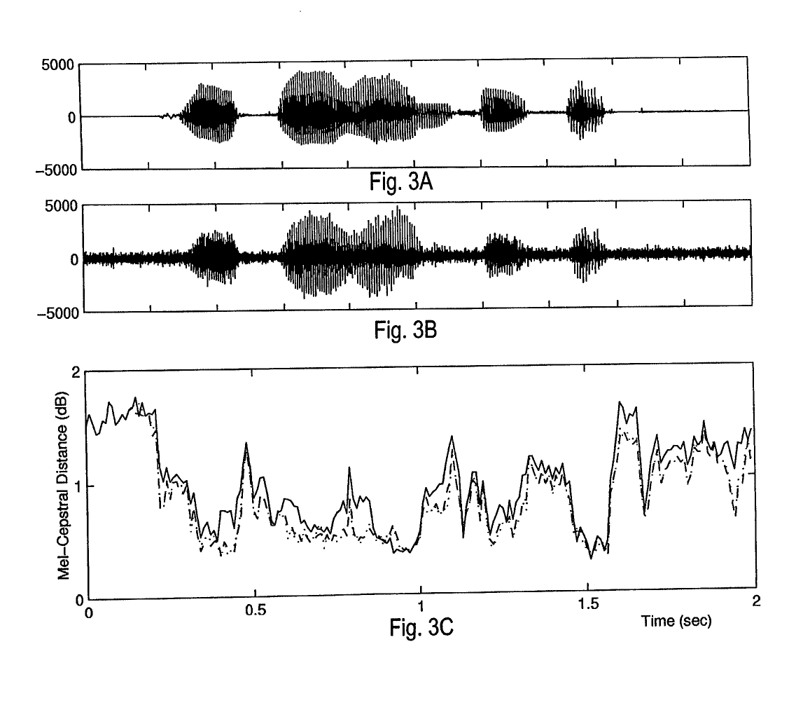

Equation (4) also shows that the amount of noise reduction is determined by how aggressively the a priori SNR is applied. The amount of noise reduction can be decreased by overestimating η(ω) and increased by underestimating η(ω). An aggressive scheme reduces the amount of noise. An aggressive scheme, however, may be harmful for ASR because it distorts the feature vectors in speech regions. There are no unique optimum parameter settings because these parameters also depend on the characteristics of input noise and the efficiency of the noise psd estimation. Generally, a more aggressive scheme is optimal for car noise signals but a less aggressive scheme is optimal for clean and babble noise signals. The settings chosen in obtaining the results presented below in FIG. 3 and Tables 1 and 2 are somewhat biased to car noise signals. The settings used are exemplary and other settings, instead of or in addition to the chosen setting, may be used in practicing this invention.

In a non-limiting and exemplary implementation, the MFCC's of the speech signals are obtained by blocking the speech signals into speech segments of 20 ms with a frame rate of 100 Hz. A Hamming window was applied to each speech segment and a 512-point Fast Fourier Transform (FFT) was computed over the windowed speech segment in implementing a short-time Fourier Transform generator 203. A pre-emphasis filter with a factor of 0.95 was applied in the frequency domain. A set of 24 filterbank log-magnitudes were obtained by applying a set of triangular weighting functions over a 4 kHz bandwidth in the spectral magnitude domain. The characteristics of these filterbanks were similar but not identical to those used in “Comparison of Parametric Representation for Monosyllabic Word Recognition in Continuously Spoken Sentences,” by Steven B. Davis, et al., IEEE Trans. ASSP, vol. 28, No. 4, (1980), pp357-366. An IDCT was applied to obtain 13 MFCC's. First and second difference MFCC's were also computed over five and three frame windows, respectively. The use of Hamming window and Fast Fourier Transform as the Fourier Transform generator and the use of the parameters for the filters and the IDCT are all exemplary. Based on this disclosure of the invention, persons of ordinary skill in the art will be able to choose other function and parameters to meet their specific design choices in practicing this invention.

The exemplary non-limiting implementations of the inventive approach have at least two major advantages over traditional acoustic noise compensation approaches. The first is its ability to make a “soft-decision” about whether a given frequency bin within an input frame corresponds to speech or noise. This allows the method to continually update noise spectral estimates in those regions of the spectrum where speech energy is low, but not update estimates of the noise spectrum for frequency bins corresponding to spectral peaks where the noise signal is masked by speech. This advantage is important when compared to common implementation of cepstrum mean subtraction (CMS), which is used to compensate for linear channel distortions. Most implementations of CMS estimate separate cepstrum averages in speech and noise regions by performing a hard classification of input frames into speech and noise frames. The second advantage of the inventive approach is to provide estimates of G_{ω}(ω) that are updated for each analysis frame. As a result, there is no need to introduce the algorithmic delay associated with buffering observation frames that is typically required for CMS.

In order to illustrate the effects of using an approach in the cepstrum domain, a mel-cepstral distance (MCD) was computed based on obtaining clean speech by processing noise-corrupted speech by the exemplary CSM approach and based on using an approach wherein the gain function is implemented within a conventional arrangement (hereinafter “SE” for speech enhancement). This distance is plotted for an example speech waveform in FIGS. 3, wherein FIG. 3A is a plot of clean speech waveform of a connected digit string “34126” spoken by a male; FIG. 3B is a plot of noisy speech waveform, which is corrupted by car noise at 10 dB SNR; and FIG. 3C is a plot of the mel-cepstral distances (MCD) between FIG. 3A and FIG. 3B, computed using the baseline conventional (_), SE (...) using an approach wherein the gain function is implemented within a conventional arrangement, and the CSM (---) methods. The waveforms in FIGS. 3A and 3B are obtained from the TI digit database (see, e.g., “A database for speaker-independent digit recognition,” by Leonard, Proc. ICASSP, San Diego, Calif., vol. 3, pp. 42.11.1-4, March 1984) and the noisy TI digit database (see, e.g., “The AURORA Experimental Framework for the Performance Evaluation of Speech Recognition Systems Under Noisy Conditions,” in Proc. ICSLP, Beijing, China, October 2000). The MCD was defined by

$$MCD = {D}_{b} \cdot \sqrt{0.1 \cdot {d}^{2} ( 0 ) + 2 {\sum }_{i = 1}^{12} {d}^{2} ( i ) ,}$$

where D_{b}(=0.1) was the constant for matching the distance value and the dB value, and d(i)=c_{clean}(i)−c_{noisy}(i) for 0≦i≦12 when c_{clean}(i) and c_{noisy}(i) were the i-th MFCC vector components obtained from clean speech and noisy speech, respectively. The scale factor of 0.1 is introduced to reproduce the weighting applied to energy in speech recognition. As shown by FIG. 3, processing by SE or CSM visibly reduces MCD with respect to the baseline uncompensated (conventional) front-end processing. This is true for all but the first 200 msec of the utterance in FIG. 3 because the speech enhancement algorithms need those initial frames to track the noise statistics.

Generally, there also exists linear channel distortion in addition to environmental acoustic noise. For example, linear channel distortions exist as caused by transducer mismatch. As explained below, the exemplary implementations described with respect to FIGS. 1 and 2 can be modified to account for channel distortions. Specifically, in the presence of channel distortions, a more accurate model of the speech corruption process would be given by:

y(n)=(s(n)+w1(n))*h(n)+w2(n)) (5)

where h(n) refers to an impulse response associated with channel distortion, and w1(n) and w2(n) are environmental acoustic noise and additive channel noise, respectively. The right-hand side of Equation (5) can be decomposed into two components: signal-dependent component, s(n) *h(n), and noise component, w1(n)*h(n)+w2(n). Following the same notation as used in Equation (2), the enhanced speech obtained after applying the signal distortion model given in Equation (5) can be written as:

s(n)*h(n)=ŝₕ(n)=y(n)*g_{w1(n)*h(n)+w2(n)} (n) (6)

where g_{w1(n)*h(n)+w2(n)} (n) denotes the time-domain nonlinear frequency dependent gain function.

Moreover, similarly to equation (4), the cepstrum for the channel corrupted clean speech can be written as:

c_{ŝ(h)}=c_{y}+c_{g(w1*h+w2)} (7)

where c_{y} and c_{g(w1*h+w2)} are the noisy speech cepstrum in Equation (5) and the noise cepstrum corresponding to g_{w1(n)*h(n)+w2(n)} (n), respectively. However, the estimated clean cepstrum has the channel distortion convolved with the actual clean speech. Accordingly, in a non-limiting and exemplary implementation, an estimate of the cepstrum domain representation for channel distortion, h(n), is needed. In such a non-limiting and exemplary implementation, a long-term average of c_{ŝ(h)} is used as an approximate estimate for channel distortion and the estimate of the clean speech in the cepstrum domain component is obtained by subtracting this estimate from c_{ŝ(h)}.

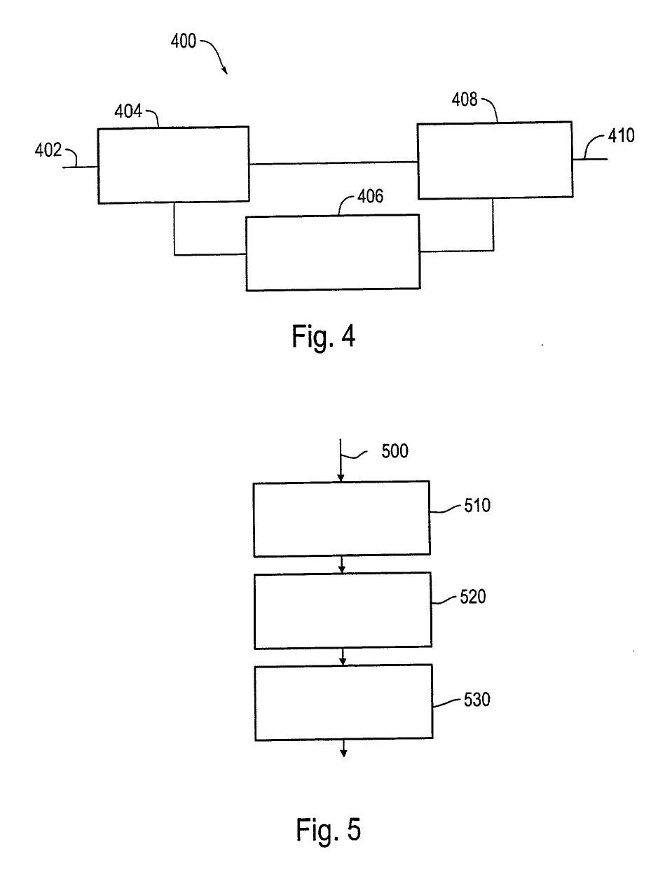

FIG. 4 is a schematic showing a non-limiting and exemplary implementation of the invention as apparatus 400, which obtains an estimate of clean speech component of a noise-corrupted speech including corruption by channel distortions. Apparatus 400 includes an input 402, a noise-corrected speech generator 404, a channel-distortion estimator 406, a combiner 408, and an output 410.

In a non-limiting and exemplary implementation, the apparatus 400 can directly receive at input 402 a signal representing noise-corrupted speech signal that is also corrupted by channel distortions. In another non-limiting and exemplary implementation, apparatus 400 can receive at input 402 such a signal after it has been preprocessed. Such a preprocessed signal includes, but is not limited to, speech that has undergone amplification or filtering.

The noise-corrected speech generator 404 is operatively connected to the input 402, from which it receives the input signal. The noise-corrected speech generator 404 is operatively arranged to process the input signal and obtain an estimate of the clean speech component of the noise-corrupted speech; the estimated clean speech component excluding environmental noise but including channel distortions effects. In a non-limiting and exemplary implementation, the noise-corrected speech generator 404 obtains in the cepstrum domain the estimated clean speech component of the noise-corrupted speech from the input signal. In an exemplary implementation, the circuit depicted in FIG. 2 can be utilized for use as the noise-corrected speech generator 404.

The channel-distortion estimator 406 is operatively connected to the noise-corrected speech generator 404, from which the channel-distortion estimator 406 obtains the estimated clean speech component of the noise-corrupted speech, which includes channel distortions effects. The channel-distortion estimator 406 is operatively arranged to provide an estimate of the channel distortions. In a non-limiting and exemplary implementation, the channel-distortion estimator 406 obtains in the cepstrum domain the estimate of the channel distortion by processing the estimated clean speech component of the noise-corrupted speech, which includes channel distortions effects. As a non-limiting example, the channel-distortion estimator 406 calculates the long-term average of the received estimated clean speech component of the noise-corrupted speech, which includes channel distortions effects, to obtain the channel distortion effects. In another non-limiting and exemplary implementation, the channel-distortion estimator 406 is provided with, rather than generates, an estimate of the channel distortion effects in the cepstrum domain.

In the non-limiting and exemplary implementation shown in FIG. 4, both the noise-corrected speech generator 404 and the channel-distortion estimator 406 are operatively connected to the combiner 408. The combiner 408 preferably combines the estimated clean speech component of the noise-corrupted speech obtained from the noise-corrected speech generator 404 (the estimated clean speech including channel distortion effects) with the estimated channel distortions obtained from the channel-distortion estimator 406 to produce the estimated clean speech component (the combination being corrected for both noise corruption and channel distortion) and provides the result to output 410. In an exemplary and non-limiting implementation, the combiner 408 subtracts a signal based on the output of the channel-distortion estimator 406 from the output of the noise-corrected speech generator 404 to produce the estimated clean speech component, which is corrected for both noise corruption and channel distortion.

In a non-limiting and exemplary implementation of FIG. 4, a buffer is used to delay the estimated clean speech component of the noise-corrupted speech, which includes channel distortions effects, obtained from the noise-corrected speech generator 404 until an estimate of the channel-distortion is obtained from the channel-distortion estimator 406. Other implementations use a memory to store the estimated clean speech component of the noise-corrupted speech obtained from the noise-corrected speech generator 404; the memory being controlled to provide the estimated clean speech component, when necessary, to the channel-distortion estimator 406. In these exemplary non-limiting implementations, the buffer or the memory can form part of the noise-corrected speech generator 404, be placed between being placed between noise-corrected speech generator 404 and the combiner 410, or form part of the combiner 408.

In a non-limiting and exemplary implementation of using the apparatus 400, the signal output from output 410 is then further processed by other devices or systems. For example, an output signal representing the estimated clean speech may be fed into an ASR system to determine the words in the clean speech included in the output signal. In another example, the output signal is preferably further processed.

TABLE 1
Comparison of word accuracies (%) and word
error rate reduction between several different front-ends on
the Aurora 2 database under the multi-training condition.

| (a) Word accuracy for clean speech. | | | |
|---|---|---|---|
| Front-end | Set A | Set C | Avg. (Impr.) |
| Baseline | 98.55 | 98.34 | 98.48 |
| SE | 98.60 | 98.59 | 98.60 (7.7%) |
| CSM | 98.61 | 98.54 | 98.59 (7.0%) |
| Baseline + CMS | 98.89 | 98.81 | 98.86 |
| SE + CMS | 98.86 | 98.80 | 98.84 (−2.1%) |
| CSM + CMS | 98.83 | 98.83 | 98.83 (−2.9%) |

| (b) Word accuracy averaged over between 0 dB to 20 dB SNR. | | | | |
|---|---|---|---|---|
| Front-end | Set A | Set B | Set C | Avg. (Impr.) |
| Baseline | 86.93 | 86.27 | 84.58 | 86.20 |
| SE | 89.65 | 88.35 | 86.79 | 88.56 (17.1%) |
| CSM | 89.21 | 88.00 | 85.94 | 88.07 (13.6%) |
| Baseline + CMS | 89.05 | 88.61 | 89.67 | 89.00 |
| SE + CMS | 89.84 | 89.14 | 89.97 | 89.59 (5.3%) |
| CSM + CMS | 89.78 | 89.12 | 90.39 | 89.64 (5.8%) |

A comparison of the performances using CS, SE, and baseline (conventional) processing as the front-end in ASR applications is presented in Tables 1 and 2. The experiments, having results presented in Table 1, were performed under the paradigm specified by the Aurora group as described in “The AURORA Experimental Framework for the Performance Evaluation of Speech Recognition Systems Under Noisy Conditions,” in Proc. ICSLP, Beijing, China, October 2000. Tables 1(a) and (b) show the word accuracies obtained using several different front-end processing for clean speech and for noisy speech, respectively. For the noisy speech results, the word accuracies were averaged between 0 dB and 20 dB SNR. In the Tables 1(a) and (b), Set A, B, and C refer to matched noise condition, mismatched noise condition, and mismatched noise and channel condition, respectively. The first three rows in the tables show that the speech enhancement algorithm reduced the word error rates (WER's) in both clean and noisy environments. The results also indicate that SE outperforms CSM when the techniques are applied without any explicit mechanism for compensation with respect to linear channel distortion.

The last three rows of Tables 1(a) and (b) display the word accuracy obtained when SE and CSM were combined with CMS and energy normalization. The tables indicate that CMS, when applied to the baseline front-end, significantly reduced WER on clean and noisy speech by about 7% sad 13%, respectively. The tables also indicate that CMS improved the recognition performance for all noise types and SNR's with respect to the baseline performance. This may be due to most of the noises being reasonably stationary. Using SE and CSM with CMS gave about a 5% reduction in WER compared to those using SE and CSM independently. Additionally, the tables indicate that CSM+CMS provided slightly more consistent performance increases across different noise types than SE+CMS. Finally, the tables indicate that CSM+CMS outperformed other methods under conditions of linear channel mismatch.

TABLE 2
Comparison of word accuracies (%) and word
error rate reduction between several different
front-ends on the Aurora 2 database under the
mismatched transducer condition.

| (a) Word accuracy for clean speech. | | | |
|---|---|---|---|
| Front-end | Set A | Set C | Avg. (Impr.) |
| Baseline | 99.23 | 99.05 | 99.17 |
| SE | 99.05 | 99.20 | 99.10 (−8.4%) |
| CSM | 99.20 | 98.95 | 99.12 (−6.0%) |
| Baseline + CMS | 99.25 | 99.30 | 99.27 |
| SE + CMS | 99.03 | 98.90 | 98.99 (−38.4%) |
| CSM + CMS | 99.28 | 99.15 | 99.24 (−4.1%) |

| (b) Word accuracy averaged over between 0 dB to 20 dB SNR. | | | | |
|---|---|---|---|---|
| Front-end | Set A | Set B | Set C | Avg. (Impr.) |
| Baseline | 70.44 | 75.10 | 70.66 | 72.35 |
| SE | 79.27 | 78.84 | 80.13 | 79.27 (25.0%) |
| CSM | 74.89 | 77.36 | 77.44 | 76.39 (14.6%) |
| Baseline + CMS | 71.62 | 75.84 | 71.49 | 73.28 |
| SE + CMS | 79.12 | 78.84 | 79.27 | 79.04 (21.5%) |
| CSM + CMS | 81.13 | 82.34 | 81.67 | 81.72 (31.6%) |

Tables 2(a) and (b) present results obtained in the mismatched transducer condition. In this condition, each digit was modeled by a set of left-to-right continuous density HMM's. A total of 274 context-dependent subword models were used; the models being trained by maximum likelihood estimation. Subword models contained a head-body-tail structure. The head and tail models were represented with three states, and the body models were represented with four states. Each state had eight Gaussian mixtures. Silence was modeled by a single state with 32 Gaussian mixtures. As a result, the recognition system had 274 subword HMM's, 831 states, and 6,672 mixtures. The training set consisted of 9,766 digit strings recorded over the public switched telephone network (PSTN).

Tables 2(a) and (b) show the word accuracy under clean and noisy test conditions. Similar to the results shown in Table 1, SE and CSM provided much better performance than the baseline. When no CMS was used, SE performed better than CSM. However, CSM was significantly better than SE when CMS was applied. Importantly, CSM+CMS reduces a WER by about 31.6%, which was much higher than the WER reduction obtained for the multi-training condition shown is Table 1. This may be due to one of the dominant sources of variability between training and testing conditions being transducer variability, which can be interpreted as channel distortion. The training database was recorded by using a vast array of transducers through the PSTN, but the testing database was not. All the test datasets in Table 2 can be considered to include significant channel distortion, while the Set C in Table 1 only has a single simulated channel mismatch. As we mentioned in the previous section, CSM+CMS could greatly improve the performance under channel distortion condition.

FIG. 5 is a flowchart outlining steps in a non-limiting and exemplary method for practicing the invention to obtain an estimate of the clean speech component of a noise-corrupted speech. Beginning in step 500, operation continues to 510 where the noise-corrupted speech is obtained. In step 520, the noise-corrupted speech is processed in the cepstrum domain to obtain the estimated clean speech component. In a non-limiting and exemplary method implementing the, step 520 preferably includes processing the input noise-corrupted speech signal (1) to obtain a frequency dependent non-linear gain function, and (2) to obtain the input noise-corrupted speech signal in the cepstrum domain. In step 530, the obtained estimated clean speech component is output.

In another non-limiting and exemplary method implementing the invention, the output signal is further processed after step 530. For example, the output signal representing the estimated clean speech component of a noise-corrupted speech may be provided to an ASR system to determine the words in the speech signal. In another example, the output signal may be further processed.

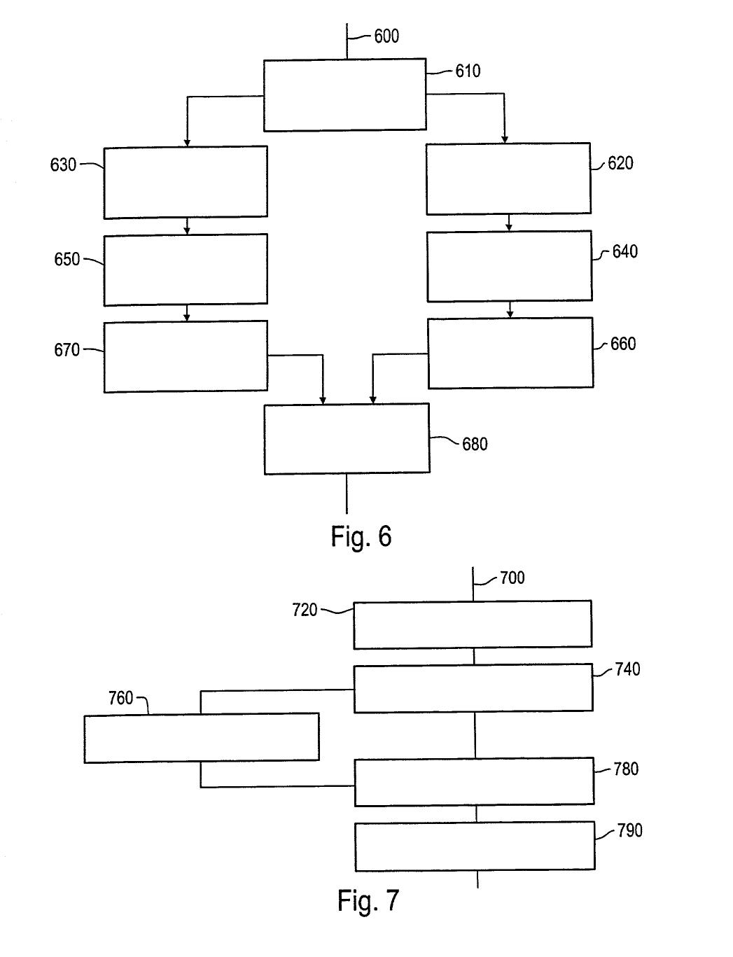

FIG. 6 is a flowchart outlining steps in a non-limiting and exemplary method for practicing the invention to obtain c_{y} and c_{gω} during the performance of step 520. Beginning in step 600, operation continues to 610 where the noise-corrupted speech y(n) is received. One flow of steps starts with step 620, where frequency dependent gain function G_{ω}(ω) is obtained based on the y(n) received in step 610, and where G_{ω}(ω) acts as a nonlinear filter generator. Next, in step 640, filtering of the signal processed by step 620 occurs. In step 640, G_{ω}(ω) is processed by optionally weighting G_{ω}(ω) in different bands by different values and by applying a homomorphic function on the transformed and optionally weighted result. This is followed by step 660, where the signal processed by step 640 is inverse-transformed to obtain the noise mel-frequency cepstrum coefficients (MFCC's). In a non-limiting and exemplary implementation, the discrete cosine transform is used in performing the inverse transform in step 660. Thus, the noise MFCC's, c_{gω}, is obtained. The signal resulting from the inverse transform performed in step 660 is provided to step 680.

In a non-limiting and exemplary implementation of step 640, optionally weights G_{ω}(ω) is processed by being optionally weighted in different bands by different values using triangular shaped weight distributions, optionally having different heights, for each band. Other exemplary non-limiting implementations of the weight distributions include rectangular, parabolic, or Gaussian distributions. The shape and height of the weighting distributions used in the exemplary implementations can be predetermined or dynamically determined. Examples of a homomorphic function that are applied to on G_{ω}(ω), which may be optionally weighted as described above, include, but are not limited to, the logarithm (natural base or any other base, including integer, rational and irrational numbers) function and series expansion approximations for the logarithm function.

Concurrently with step 620, in step 630, the Fourier transform, Y(ω), of the noise-corrupted speech signal is preferably obtained. In other exemplary implementations, other transforms may be used. In a non-limiting and exemplary implementation, a short-time Fast Fourier Transform is used to obtain Y(ω). Next, in step 650, filtering of the signal processed by step 630 occurs. Step 650 preferably includes optionally weighting Y(ω) in different bands by different values and applying a homomorphic function on the transformed and optionally weighted result. This is followed by step 670, where the signal processed by step 650 is inverse transformed to obtain the MFCC's of the noise-corrupted speech signal. The signal resulting from the inverse transform performed in step 670 is provided to step 680. In a non-limiting and exemplary implementation, the discrete cosine transform is used in performing the inverse transform in step 670. Thus, the MFCC's of the noise-corrupted speech signal, c_{y}, is obtained.

In a non-limiting and exemplary implementation of step 650, Y(ω) is processed by optionally weighting Y(ω) in different bands by different values using triangular shaped weight distributions, optionally having different heights, for each band. Other exemplary non-limiting implementations of the weighting distribution include rectangular, parabolic, or Gaussian shaped distributions. The shape and height of the weighting distributions used in the exemplary implementations can be predetermined or dynamically determined. Examples of a homomorphic function that are applied on Y(ω), which may be optionally weighted as described above, include, but are not limited to, the logarithm (natural base or any other base, including integer, rational and irrational numbers) function and series expansion approximations for the logarithm function.

In various exemplary implementations of the methods using steps 660 and 670 in practicing the invention, preferably the same, or different, inverse transform functions are used in steps 660 and 670.

Next, in step 680 the obtained c_{y} and c_{gω} are preferably combined (for example, by being added) and made available for optional further optional processing.

Equations (1)-(4) can be used in practicing the exemplary method including the steps outlined in FIG. 6.

FIG. 7 is a flowchart outlining steps in a non-limiting and exemplary method for practicing the invention to obtain an estimate of clean speech component of a noise-corrupted speech including corruption by channel distortions. Beginning in step 700, operation continues to 720 where the noise-corrupted speech y(n) is received.

In a non-limiting and exemplary implementation, step 720 directly receives a signal representing noise-corrupted speech signal that is also corrupted by channel distortions. In another non-limiting and exemplary implementation, step 720 receives such a signal after it has been preprocessed. Such a preprocessed signal includes, but is not limited to, speech that has undergone amplification or filtering.

Next, step 740 processes the input signal and obtains an estimate of the clean speech component of the noise-corrupted speech; the estimated clean speech component excluding environmental noise but including channel distortions effects. In a non-limiting and exemplary implementation, step 740 obtains in the cepstrum domain the estimated clean speech component of the noise-corrupted speech from the input signal. In an exemplary implementation, the method depicted in FIG. 6 can be utilized for use in practicing step 740.

Next, step 760 provides an estimate of the channel distortions. In a non-limiting and exemplary implementation, the estimate of the channel distortion in the cepstrum domain is obtained by processing the estimated clean speech component of the noise-corrupted speech, which includes channel distortions effects. As a non-limiting example, step 760 includes calculating the long-term average of the received estimated clean speech component of the noise-corrupted speech, which includes channel distortions effects, to obtain the channel distortion effects. In another non-limiting and exemplary implementation, step 760 is provided with, rather than generates, an estimate of the channel distortion effects in the cepstrum domain.

Next, at step 780, the estimated clean speech component of the noise-corrupted speech obtained by step 740 (the estimated clean speech including channel distortion effects) and the estimated channel distortions obtained from step 760 are preferably combined to produce the estimated clean speech component (the combination being corrected for both noise corruption and channel distortion). In a non-limiting and exemplary implementation of step 780, the result obtained from step 760 is subtracted from the result obtained in step 740. At step 790, the result of the combining step 780 is outputted.

In a non-limiting and exemplary implementation of FIG. 7, a buffer can be used to delay the estimated clean speech component of the noise-corrupted speech, which includes channel distortions effects, obtained by step 740 until an estimate of the channel-distortion is obtained by step 780. Other implementations use a memory to store the estimated clean speech component of the noise-corrupted speech obtained by step 740; the memory providing the estimated clean speech component, when necessary, to step 760.

In a non-limiting and exemplary implementation of the invention, the signal output by step 790 is then further processed by further steps. In one exemplary and non-limiting implementation, an output signal representing the estimated clean speech is processed to determine the words in the clean speech included in the output signal. In another exemplary and non-limiting implementation, the output signal is then further processed.

The signal generating and processing devices 100, 200, and 400 are, in various exemplary embodiments, each implemented on a programmed general-purpose computer. However, these devices can each also be implemented on a special purpose computer, a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA or PAL, or the like. In general, any device, capable of implementing a finite state machine that is in turn capable of implementing the flowcharts shown in FIGS. 5-7, can be used to implement the signal generating and processing devices 100, 200, and 400.

It should be understood that circuits depicted in FIGS. 1, 2, and 4 can be implemented as hardware modules or software modules and that each of the circuits, modules, or routines shown in FIGS. 1, 2, and 4-7 can be implemented as portions of a suitably programmed general purpose computer. Alternatively, each of the circuits, modules, or routines shown in FIGS. 1, 2, and 4-7 can be implemented as physically distinct hardware circuits within an ASIC, or using a FPGA, a PDL, a PLA, a PAL or a digital signal processor, or using discrete logic elements or discrete circuit elements. The particular form each of the circuits, modules, or routines shown in FIGS. 1, 2, and 4-7 will take is a design choice and will be obvious and predicable to those skilled in the art.

For example, the modules can be implemented as carrier waves carrying control instructions for performing the steps shown in FIGS. 5-7 and the segments of this disclosure describing in more detail the various exemplary implementations. In addition, the signal generating and processing devices 100, 200, and 400 can each be integrated into a single system for ASR or speech enhancement. Various exemplary implementations may be rendered more compact by avoiding redundancies in constituent circuits, for example, by having one memory circuit or module or one controller circuit or module. For example, the exemplary device depicted by FIG. 2 can be modified so that a single processor replaces several, and possibly all, of the components 202-208 and performs their functions, either serially or in parallel. Various other exemplary implementations may retain redundancies to enable parallel processing, for example.

Additionally, the implementation of the non-linear gain function described by reference to Equation 4 is non-limiting. Alternatively, any other non-linear methodology to obtain the gain function can be used. In an exemplary non-limiting implementation, the Wiener Filter, as, for example, described in section 13.3 of “Numerical Recipes in FORTRAN,” second edition, by Press et al., pp 539-542 (1992) and references cited therein, which is explicitly incorporated herein in its entirety and for all purposes, can be used instead of, or in addition to, the implementation of the non-linear gain function described by reference to Equation 4.

While this invention has been described in conjunction with the exemplary embodiments outlined above, it is evident that many alternatives, modifications, and variations will be apparent to those skilled in the art. Accordingly, the exemplary embodiments of the invention, as set forth above, are intended to be illustrative, not limiting. Various changes may be made without departing from the spirit and scope of the invention.

What is claimed is:

1. A method for estimating clean speech component in a noise-corrupted speech, the method comprising:
receiving a signal representing noise-corrupted speech;
processing the received signal using a nonlinear gain function that is based on the noise-corrupted speech signal to generate a first signal;
obtaining a transform of the received signal to generate a second signal; and
generating a third signal representing an estimate of the clean speech component of the noise-corrupted speech by adding signals based on the first and second signal.

2. The method of claim 1, wherein the processing of the received signal further includes obtaining the first signal in the cepstrum domain.

3. The method of claim 2, wherein the transform of the received signal is a Fourier Transform of the received signal.

4. The method of claim 3, further including processing the third signal to obtain a fourth signal representing an estimate of channel distortion effects.

5. The method of claim 4, further including combining the third and fourth signals to obtain fifth signal representing an estimate of clean speech component that includes substantially reduced channel distortion effects.

6. The method according to claim 2, further including performing an inverse transform.

7. The method according to claim 2, further including performing a filtering analysis.

8. A module for estimating clean speech component in a noise-corrupted speech, the device comprising:
an input module receiving a signal representing noise-corrupted speech;
a nonlinear gain generator module operatively connected to the input module and operatively arranged to process the received signal using a nonlinear gain function that is based on the noise-corrupted speech signal to generate a first signal;
a transformer module operatively connected to the non-linear gain generator module and operatively arranged to obtain a transform of the received signal to generate a second signal; and
a combiner module operatively connected to both the nonlinear gain generator module and the transformer module and arranged to generate a third signal representing an estimate of clean speech component of the noise-corrupted speech by adding signals based on the first and second signals.

9. The device of claim 8, wherein the non-linear gain generator module is connected to a module that obtains the first signal in the cepstrum domain.

10. The device of claim 9, wherein the transformer module obtains the Fourier Transform of the received signal.

11. The device of claim 10, further including a channel distortion generator module operatively arranged to process the third signal to obtain a fourth signal representing an estimate of channel distortion effects.

12. The device of claim 11, further including a second combiner module operatively connected to at least the channel distortion generator module and arranged to combine the third and fourth signals to obtain a fifth signal representing an estimate of clean speech component that includes substantially reduced channel distortion effects.

13. The device of claim 9, further including an inverse transformer module.

14. The device of claim 9, further including a filter-bank analysis module.
